(19) United States
(12) Patent Application Publication
(10) Pub. No.: US 2004/0051458 A1
(43) Pub. Date: Mar. 18, 2004

(54) Discharge lamp

(75) Inventors: Akira Kanagawa, Hyogo-ken (JP); Masanobu Kobayashi, Hyogo-ken (JP)

Correspondence Address: NIXON PEABODY, LLP, 401 9TH STREET, NW, SUITE 900, WASINGTON, DC, 20004-2128, US

(73) Assignee: Ushiobenki Kabushiki Kaisha, Tokyo (JP)

(21) Appl. No.: 10/656,244

(22) Filed: Sep. 8, 2003

(30) Foreign Application Priority Data
Sep. 18, 2002 (JP) 2002-272825

(51) Int. Cl. H01J 17/18

(52) U.S. Cl. 313/623

(57) ABSTRACT

An electrode assembly for a discharge lamp in which the upholding part of the electrode can be fitted into the electrode with extremely high accuracy is obtained by the electrode having a first concave portion and a second concave portion, a buffer component being located in the second concave portion. The upholding part of the electrode has a cylindrical end part which adjoins a tapering part. The cylindrical part of the electrode upholding part is positioned in the first concave part, and the upholding part of the electrode is fitted into the electrode such that the tapering part presses the buffer component flat.

### BACKGROUND OF THE INVENTION

1. Field of the Invention

The invention relates to a discharge lamp electrode assembly.

2. Description of the Related Art

Conventionally, a discharge lamp has a bulb with hermetically sealed tubes on opposite ends of the arc tube which forms the emission space. Within the arc tube of this bulb, there are a pair of opposed electrodes (anode and cathode), and moreover, for example, it is filled with a rare gas and mercury. The electrodes are each mounted in the tip area of an upholding part of the electrode which extends along the tube axis from the hermetically sealed tubes of the bulb in a direction toward the arc tube and are supported by the latter.

As one measure for mounting the electrode on the tip area of the upholding part of the electrode, a process is known in which an open concave part is formed on the end of the electrode, into which the tip area of the upholding part of the electrode is fitted via a buffer component. This process is described specifically below.

As is shown in FIG. 5(a), on the end 50b of the electrode 50, a tapering concave part 50a is formed such that its diameter reduces in the direction from an open end toward the tip of the electrode 50. Moreover, the tip area 51a of the upholding part 51 of the electrode is worked into a form which is matched to the concave part 50a of the electrode 50, i.e., it tapers such that its diameter diminishes in the direction to the tip. Furthermore, a buffer component 52 is formed on the peripheral surface of the tip area 51a.

Next, as shown in FIG. 5(b), the tip area 51a of the upholding part 51 of the electrode is inserted into the concave part 50a of electrode 50. Furthermore, as shown in FIG. 5(c), the tip area 51a of the upholding part 51 of the electrode is force fitted such that the entire tip area 51a is held in the concave part 50a of the electrode 50. In this way, the buffer component 52 is pressed flat between the tip area 51a and the concave part 50a. The tip area 51a of the upholding part of the electrode 51 is fitted into the concave part 50a of the electrode 50 and attached. Such a process is described, for example, in Japanese patent disclosure document 2001-23566 (corresponds to U.S. Pat. No. 6,459,202) in conjunction with FIG. 7.

However, this process has the following disadvantages.

The buffer component 52 that is formed on that the tip area 51a of the upholding part 51 of the electrode is wound with a molybdenum foil, a tantalum plate or the like. The thickness of the buffer component 52 is adjusted, that is, the thickness, the number of windings and the winding position of the molybdenum foil, the tantalum plate or the like to be used are adjusted by repeated tests of the manufacturer. There is the disadvantage that the fit of the electrode 50 and of the upholding part 51 of the electrode is subject to variances and that the accuracy of the fit is low.

The tip area 51a of the upholding part 51 of the electrode which is fitted into the concave part 50a of the electrode 50 is also made tapered for the following reasons:

in conjunction with the adjustment of the thickness of the buffer component 52, i.e., the thickness, the winding number, the winding position and the like of the molybdenum foil, the tantalum plate or the like which is to be used; and

the inside of the concave part 50a of the electrode 50 is made tapered.

In the case in which the tip area 51a is inserted into the concave part 50a, the axis Y of the upholding part 51 of the electrode must actually agree with the axis X of the electrode 50. However, there were cases in which the axes deviate from one another.

### SUMMARY OF THE INVENTION

The present invention was devised in order to eliminate the above described disadvantages in the prior art.

A primary object of the invention is to devise a discharge lamp in which the tip of the upholding part of the electrode can securely fit into the open end of the concave part of the end of the electrode with extremely high accuracy of fit, in which variances of the accuracy of the fit among discharge lamps can be eliminated, and in which the axis of the upholding part of the electrode can be brought reliably into agreement with the axis of the electrode.

This object is achieved in accordance with the invention by an electrode assembly for discharge lamp which has an electrode which is supported by an upholding part of the electrode, the electrode having an open concave part on one end which has a first concave portion with a smaller diameter which is located on the inside of the electrode, and a second concave portion with a larger diameter which adjoins the first concave part and which is located on the side of the electrode end, and furthermore, in the second concave portion, there is a cylindrical metallic buffer part with an inside peripheral surface which runs parallel to the electrode axis. The tip of the upholding part of the electrode has a cylindrical part which adjoins a tapering part and is fitted into the first concave portion of the electrode and supports this electrode such that the tapering part presses the buffer component flat.

### BRIEF DESCRIPTION OF THE DRAWINGS

FIG. 1 is a longitudinal cross-sectional view of the arrangement of a discharge lamp in accordance with the invention;

FIGS. 2(a) to 2(d) each show a step in the process by which an anode is mounted to fit on the tip of the upholding part of the electrode,

FIG. 3 is a perspective of the buffer component which is used in the fitting arrangement of the discharge lamp of the invention;

FIG. 4 is an enlarged schematic of the fitting arrangement of the discharge lamp according to the invention, and

FIGS. 5(a) to 5(c) each show a step in a conventional process by which an anode is mounted to fit on the tip of the upholding part of the electrode.

### DETAILED DESCRIPTION OF THE INVENTION

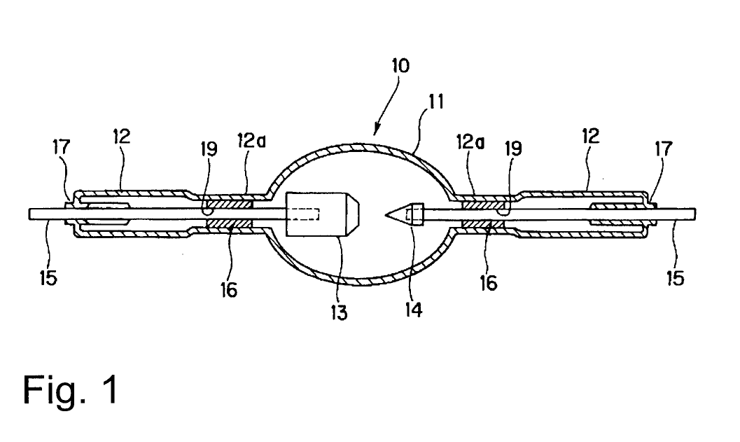

FIG. 1 is a schematic cross section of one example of an arrangement of a discharge lamp in accordance with the invention which has a bulb 10 made of silica glass that is formed with an ellipsoidal arc tube 11 and hermetically sealed tubes 12 which extend outward from opposite ends of the arc tube 11. At each hermetically sealed tube 12, a compressed part 12a of reduced diameter is formed near the arc tube 11.

Within the arc tube 11 of the bulb 10, an anode 13 and a cathode 14 made of tungsten are each mounted and held to fit on the tip of the molybdenum cylindrical upholding part 15 of the electrode in opposition to each other.

The respective upholding part 15 of the electrode extends within the respective hermetically sealed tube 12, the ends of which project out of the hermetically sealed tube 12. On the outer end of the hermetically sealed tube, the tube and the upholding part 15 of the electrode are welded to one another, forming a hermetically closed seal area 17.

Within the hermetically sealed tube 12, there is a sleeve component 16 of silica glass which has a through opening 19 which is matched to the outside diameter of the upholding part 15 of the electrode in the state in which is it penetrated by the upholding part 15 of the electrode. This sleeve component 16 is supported by the compressed part 12a of the hermetically sealed tube.

Within the arc tube 11 of the bulb 10, there are a filler gas which is comprised of a rare gas, such as xenon, argon, krypton or the like or of a gas mixture thereof, and if necessary, an emission substance, such as mercury or the like.

The pressure of the filler gas during filling is, for example, 0.1 atm to 10 atm. In the case of using mercury as the emission substance, the filler amount is, for example, from 0.5 mg/cm³ to 60 mg/cm³ weight per unit of inside volume of the arc tube 11 of the bulb 10.

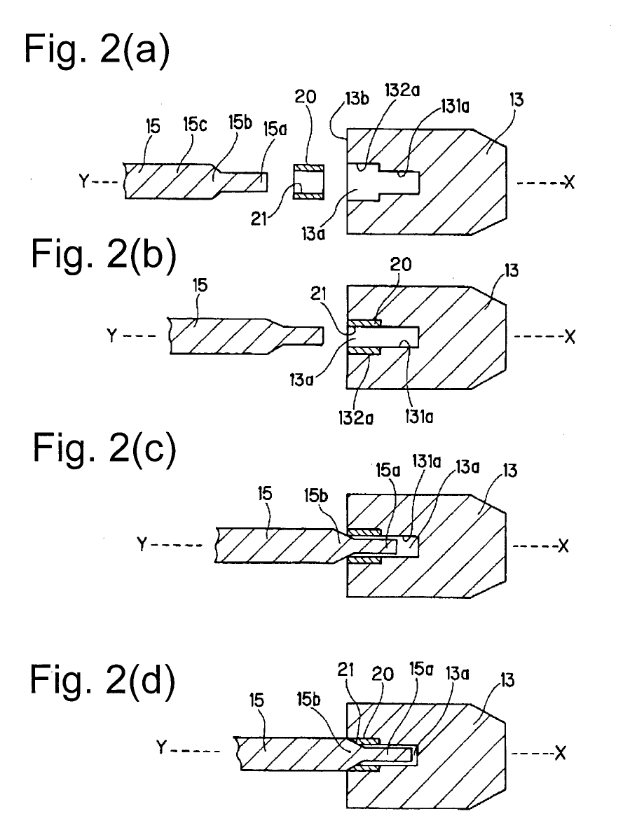

The sequence with which the upholding part of the electrode is fitted into the electrode is described below using FIGS. 2(a) to 2(d).

As is shown in FIG. 2(a), the electrode 13 has a concave part 13a which opens at the end 13b. This concave part 13a has a first cylindrical concave portion 131a with a smaller diameter which is located on the inside of the electrode, and a second cylindrical concave portion 132a with a larger diameter which adjoins this first concave part 131a and is located at the electrode end 13b. This means that the inside diameter of the first concave portion 131a is smaller than the inside diameter of the second concave portion 132a.

The tip of the upholding part 15 of the electrode is made as a cylindrical part 15a which adjoins a tapering part 15b with a diameter which increases in the direction to the outer end of the upholding part 15 of the electrode. The tapering part 15b adjoins the body 15c. The outside diameter of the cylindrical part 15a is smaller than the inside diameter of the first concave portion 131a.

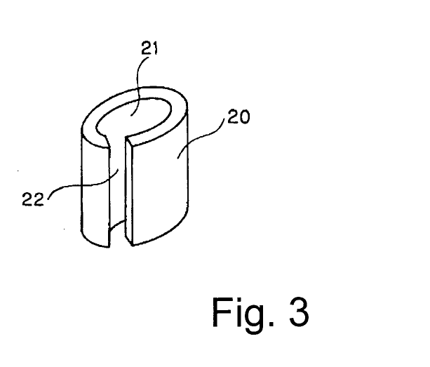

A buffer component 20, as is shown in FIG. 3, is a partially cylindrical component of metallic tantalum which is provided with a gap 22 that extends in the axial direction, giving buffer component 20 an essentially C-shaped cross section. The buffer component 20 has an inner peripheral surface 21.

As is shown in FIG. 2(b), the buffer component 20 is pressed from the outside into the second concave part 132a and is installed in a plastically deformed state. The inside diameter of this buffer component 20 is larger than the outside diameter of the cylindrical part 15a of the upholding part 15 of the electrode and smaller than the outside diameter of the body 15c of the upholding part 15 of the electrode. The inner peripheral surface 21 of the buffer component 20 runs parallel to the longitudinal axis X of the electrode.

Next, as is shown in FIG. 2(c), the cylindrical part 15a of the upholding part 15 of the electrode and the tapering part 15b are inserted into the concave part 13a of the anode 13.

The first concave part 131a is formed on the axis X of the electrode 13. On the other hand, the cylindrical part 1 Sa of the upholding part 15 of the electrode is formed on the longitudinal axis Y of the upholding part 15 of the electrode. When the cylindrical part 15a is pushed into the first concave part 131a, between the cylindrical part 15a and the first concave part 131a, a gap is formed. Since this gap is very narrow, the first concave part 131a acts as a guide when the cylindrical part 15a is inserted. The cylindrical part 15a is thus located in the middle of the first concave part 131a. As a result, the upholding part 15 of the electrode can be centered and the axis Y of the upholding part of the electrode 15 and the axis X of the anode 13 agree.

Furthermore, as is shown in FIG. 2(d), the upholding part 15 of the electrode is fitted precisely into the anode 13 by the cylindrical part 15a of the upholding part 15 of the electrode and the tapering part 15b being pressed more deeply into the concave part 13a of the anode 13.

This circumstance is described specifically below.

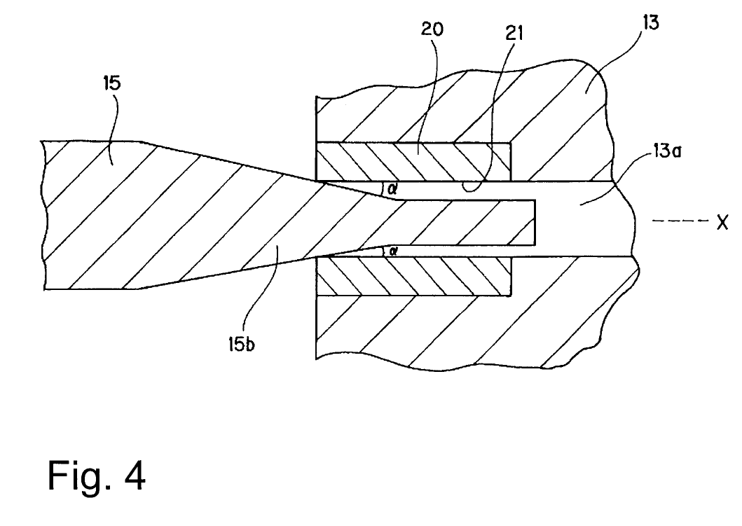

As is shown in FIG. 4, the inside peripheral surface 21 of the buffer component 20 is parallel to the axis X of the electrode 13. The angle α which is formed by the tapering part 15b of the upholding part 15 of the electrode and the inside peripheral surface 21 is therefore constant over the entire circumference. When the tapering part 15b is pressed into the buffer component 20, the tapering part 15b is pressed against the inside peripheral surface 21 of the buffer component 20 with a force which is directed essentially uniformly outward. In the buffer component 20, the side of its inside peripheral surface 21 is pressed essentially uniformly flat by the tapering part 15b, by which the upholding part 15 of the electrode is fitted reliably into the anode 13 and moreover with great accuracy of the fit.

The buffer component 20 is produced mechanically and has a certain shape, as is shown in FIG. 3. The buffer components 20 therefore have hardly any individual differences among one another.

Since, in the conventional process of winding the tip of the upholding part of the electrode with a metal foil, the thickness, the winding number and the winding position have been determined according to the experience of the manufacturer, there were variances in the accuracy of the fit between the upholding part of the electrode and the electrode for each discharge lamp. With the present invention, the experience of the manufacturer is not critical and the buffer component 20 is installed with a certain shape in the second concave portion 132a. In this way, individual differences are lost between the states in which the buffer component 20 is pressed flat between the tapering part 15b of the upholding part 15 of the electrode and the second concave portion 132a. Thus, in each discharge lamp, the variances of the accuracy of the fit between the upholding part of the electrode and the electrode can be eliminated and the accuracy of the fit can be kept constant.

The anode 13 was described above. However, the cathode 14 has the same arrangement and thus the same effect and the same action.

Test Example

According to the arrangement as shown in FIGS. 2(a) to 2(d), under the conditions described below, a total of ten assemblies were produced, each assembly having the anode 13, the upholding part 15 of the electrode and the buffer component 20.

(Anode 13)

Material: tungsten

Diameter: 15 mm

Length in the axial direction: 27 mm

Inside diameter of the first concave part: 3.2 mm

Length in the axial direction of the first concave part 131a: 7.0 mm

Inside diameter of the second concave part 132a: 3.8 mm

Length of the second concave part 132a in the axial direction: 5.0 mm

(Upholding Part 15 of the Electrode)

Material: tungsten

Outside diameter of the cylindrical part 15a: 3.0 mm

Length of the cylindrical part 15a in the axial direction: 5.0 mm

Slope of the tapering part 15b: 3 mm/10 mm

Length of the tapering part 15b in the axial direction: 3.3 mm

Outside diameter of the body 15c: 4.0 mm

(Buffer Component 20)

Material: tantalum

Outside diameter: 3.78 mm

Inside diameter: 3.2 mm

Thickness: 0.29 mm

Length in the axial direction: 5.0 mm

Using the anode 13, the upholding part 15 of the electrode and the buffer component 20, after the steps shown in FIGS. 2(a) to 2(d), the upholding part 15 of the electrode is fitted precisely into the concave part 13a of the anode 13 with a force of roughly 1 ton.

In order to measure the amount of fit between the anode 13 and the upholding part 15 of the electrode, the force for pulling the upholding part 15 of the electrode out of the anode 13 (tensile strength) was measured. In this case, it was roughly 250 kgf to 350 kgf. The following was confirmed.

Between the products, there were only small variances in the accuracy of the fit. Furthermore, the accuracy of the fit between the anode 13 and the upholding part 15 of the electrode was extremely large.

(Comparison Test)

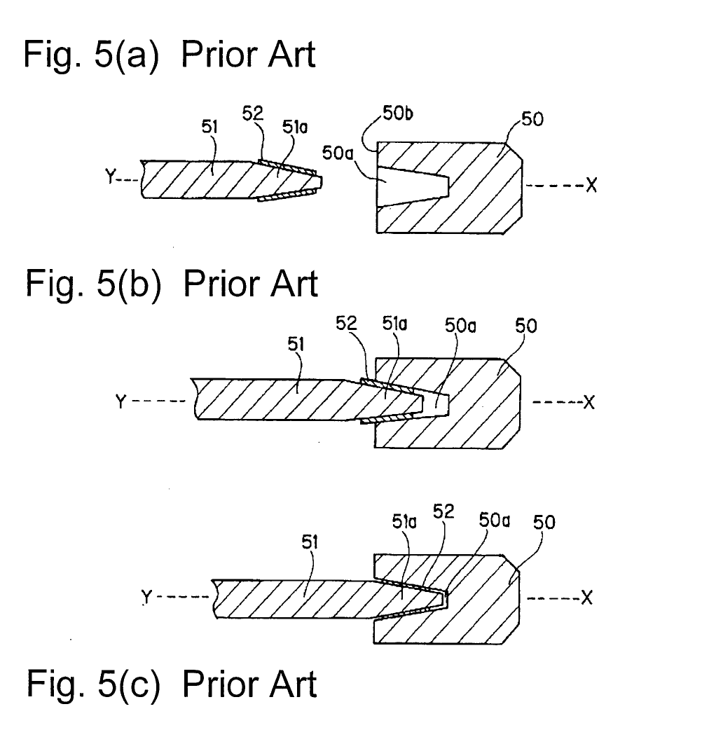

According to the arrangement shown in FIGS. 5(a) to 5(c), under the conditions described below, a total of ten assemblies were produced, each assembly having the anode 50, the upholding part 51 of the electrode and the buffer component 52.

(Anode 50)

Material: tungsten

Diameter: 15 mm

Length in the axial direction: 27 mm

Slope of the concave part 50: 0.6 mm/20 mm

Diameter of the tip area of the concave part 50: 4.06 mm

Diameter of the opening on the side on the end 50b of the concave part 50: 4.1 mm

Length of the concave part 50 in the axial direction: 12 mm

(Upholding Part 51 of the Electrode)

Material: tungsten

Diameter of the tip of the tip area 51a: 3.9 mm

Slope of the tip area 51a: 0.06 mm/20 mm

Length of the tip area 51a in the axial direction: 16 mm

(Buffer Component 52)

Material: tantalum foil

Height: 10 mm

Width: 6 mm

Thickness: 0.05 mm

Winding method: 1.5 turns

Using the anode 50, the upholding part 51 of the electrode and the buffer component 52, after the steps shown in FIGS. 5(a) to 5(c), the upholding part 51 of the electrode was fitted precisely into the concave part 50a of the anode 50 with a force of roughly 1 ton.

In order to measure the amount of fit between the anode 50 and the upholding part 51 of the electrode, the force for pulling the upholding part 51 of the electrode out of the anode 50 (tensile strength) was measured. In this case, it was in the range from roughly 40 kgf to 250 kgf. There were great variances between the products. The accuracy of the fit between the anode and the upholding part of the electrode compared to the accuracy of the fit between the anode and the upholding part of the electrode of the invention was less.

Action of the Invention

As was described above, in the discharge lamp of the invention, the cylindrical portion of the upholding part of the electrode is pushed into the first concave part with a smaller diameter of the electrode, the cylindrical metallic buffer component is located in the second concave part with a greater diameter and the upholding part of the electrode is fitted precisely into the concave part of the electrode such that the side of the inside peripheral surface of this buffer component is pressed flat by the tapering part of the upholding part of the electrode. The upholding part of the electrode is therefore securely mounted in the electrode, and moreover, in a state in which extremely great accuracy of the fit is maintained. Furthermore, the variances of the accuracy of the fit among discharge lamps is eliminated. Because the first concave part of the electrode acts as a guide when the cylindrical part of the upholding part of the electrode is inserted, the cylindrical part is mounted along the middle of the first concave part. Therefore, the axis of the upholding part of the electrode can be reliably brought into agreement with the axis of the electrode.

What is claimed is:

1. Discharge lamp electrode assembly, comprising:
an electrode upholding part by which an electrode is supported, the electrode having an opening in one end thereof,
wherein the opening has a first concave portion and a second concave portion, the first concave portion having a smaller diameter than second concave portion and being located inwardly thereof, the second concave portion adjoining the first concave portion and being located at the end with the opening,
wherein a substantially cylindrical metallic buffer part is provided in the second concave portion and has an inner peripheral surface which runs parallel to a longitudinal axis of the electrode,
wherein an end portion of the upholding part is cylindrical and adjoins a tapering part,
wherein the cylindrical end portion of the upholding part of the electrode is located within the first concave portion of the electrode, and
wherein the upholding part is fitted into the opening and supports the electrode such that the tapering part of the upholding part of the electrode is held in an interference fit in the buffer component.

2. Discharge lamp electrode assembly as claimed in claim 1, wherein the buffer component has a smaller thickness in an area adjacent to the electrode end with the opening than in a remaining area, having been compressed by the tapering part.

3. Discharge lamp electrode assembly as claimed in claim 1, wherein the first and the second concave portions each have an essentially cylindrical shape.

4. Discharge lamp electrode assembly as claimed in claim 3, wherein the inside diameter of the first concave portion has a slightly larger diameter than an outside diameter of the cylindrical end portion of the upholding part of the electrode.

5. Discharge lamp electrode assembly as claimed in claim 4, wherein the inside diameter of the second concave end portion and the thickness of the buffer component are dimensioned such that the inside diameter of the buffer component corresponds essentially to the inside diameter of the first concave portion.

6. Discharge lamp electrode assembly as claimed in claim 5, wherein the buffer component has an essentially C-shaped cross section.

7. Discharge lamp electrode assembly as claimed in claim 6, wherein the buffer component is made of tantalum.

8. Discharge lamp electrode assembly as claimed in claim 1, wherein the inside diameter of the first concave portion has a slightly larger diameter than an outside diameter of the cylindrical end portion of the upholding part of the electrode.

9. Discharge lamp electrode assembly as claimed in claim 8, wherein the inside diameter of the second concave end portion and the thickness of the buffer component are dimensioned such that the inside diameter of the buffer component corresponds essentially to the inside diameter of the first concave portion.

10. Discharge lamp electrode assembly as claimed in claim 9, wherein the buffer component has an essentially C-shaped cross section.

11. Discharge lamp electrode assembly as claimed in claim 10, wherein the buffer component is made of tantalum.

12. Discharge lamp electrode assembly as claimed in claim 1, wherein the inside diameter of the second concave end portion and the thickness of the buffer component are dimensioned such that the inside diameter of the buffer component corresponds essentially to the inside diameter of the first concave portion.

13. Discharge lamp electrode assembly as claimed in claim 1, wherein the buffer component has an essentially C-shaped cross section.

14. Discharge lamp electrode assembly as claimed in claim 13, wherein the buffer component is made of tantalum.
